(19) United States
(12) Patent Application Publication
(10) Pub. No.: US 2026/0284744 A1
(43) Pub. Date: Sep. 24, 2026

(54) MANUFACTURING METHOD AND MANUFACTURING APPARATUS FOR POWDER COMPACT

(71) Applicant: TOYO SEIKO CO., LTD., Yatomi-shi, Aichi (JP)

(72) Inventors: Yoshihiro WATANABE, Yatomi-shi, Aichi (JP); Mitsuru HANDA, Yatomi-shi, Aichi (JP); Ryosuke WATANABE, Yatomi-shi, Aichi (JP)

(73) Assignee: TOYO SEIKO CO., LTD., Yatomi-shi, Aichi (JP)

(21) Appl. No.: 19/475,661

(22) PCT Filed: Apr. 16, 2024
(86) PCT No.: PCT/JP2024/015161

§ 371 Date: Oct. 15, 2025

(30) Foreign Application Priority Data
Apr. 18, 2023 (JP) 2023-068009
Apr. 18, 2023 (JP) 2023-068010
Apr. 18, 2023 (JP) 2023-068011

(51) Int. Cl. B22F 10/10; B22F 10/64; B22F 12/55; B22F 12/60; B29C 64/141; B29C 64/205; B29C 64/336; B29C 71/02; B33Y 10/00; B33Y 30/00; B33Y 40/20; C03B 19/09

(52) U.S. Cl. CPC B22F 10/10; B22F 10/64; B22F 12/55; B22F 12/60; B29C 64/141; B29C 64/205; B29C 64/336; B29C 71/02; B33Y 10/00; B33Y 30/00; B33Y 40/20; C03B 19/09; B22F 2998/10

(57) ABSTRACT

A manufacturing method for a powder compact disclosed in this specification includes a material supplying step and a pressure applying step. The material supplying step includes a binder supplying step of supplying a binder into a forming chamber and a powder supplying step of supplying powder into the forming chamber, wherein the binder and the powder are separately supplied into the forming chamber. The pressure applying step applies a pressure to the binder and the powder supplied into the forming chamber to impregnate the binder into the powder.

### TECHNICAL FIELD

The specification relates to art for manufacturing a powder compact from powder (e.g., metal dust, glass dust, resin dust, etc.).

### BACKGROUND ART

Powders generated in factories and the like include, for example, dust emitted from a shot peening machine. Although recovering and using these powders as valuable resources has been considered, as things stand now, they are still discarded as wastes. Regardless of whether powders are reused or discarded, powders generated in factories and the like need to be recovered at their sources and transported to facilities for reuse or disposal. In order to facilitate the handling of recovered powders during the transportation from the sources to the facilities, technologies for solidifying recovered powders have been developed (e.g., Japanese Patent Application Publication No. 2003-275898). In the technique described in Japanese Patent Application Publication No. 2003-275898, a grinding sludge, which contains a coolant discharged from a grinding machine, is filtered into a concentrated sludge and then the concentrated sludge is compressed for solidification.

### SUMMARY OF INVENTION

### Technical Problem

The method described in Japanese Patent Application Publication No. 2003-275898 is intended for a concentrated sludge and thus may have difficulty in solidifying powders depending on the type of recovered powder. The specification discloses teachings allowing for appropriate solidification of recovered powder.

### Solution to Technical Problem

A first technique disclosed in the specification relates to a manufacturing method for a powder compact. The manufacturing method for a powder compact may comprise a material supplying step and a pressure applying step. The material supplying step may comprise a binder supplying step of supplying a binder into a forming chamber and a powder supplying step of supplying powder into the forming chamber, wherein the binder and the powder are separately supplied into the forming chamber. In the pressure applying step, a pressure is applied to the binder and the powder supplied into the forming chamber to impregnate the binder into the powder.

In the manufacturing method above, the binder and the powder are separately supplied into the forming chamber, which allows the binder and the powder to be supplied into the forming chamber without these materials being stagnated in their supply passages. Even though the binder and the powder are separately supplied into the forming chamber, applying a pressure to these materials impregnates the binder into the powder, allowing the binder to be distributed throughout the powder. In this way, the powder can be solidified to manufacture a powder compact.

A manufacturing apparatus for a powder compact according to the first technique disclosed in the specification may comprise a forming chamber, a binder supplying device for supplying a binder to the forming chamber, a powder supplying device for supplying powder to the forming chamber, and a pusher. The forming chamber may comprise an inlet through which the binder from the binder supplying device and the powder from the powder supplying device are supplied, and an accommodation space in which the binder and the powder supplied through the inlet are accommodated. The pusher may apply a pressure to the binder and the powder accommodated in the accommodation space. In this manufacturing apparatus, the binder supplying device and the powder supplying device are separate devices, and thus the binder and the powder can be separately supplied into the accommodation space of the forming chamber. Therefore, the manufacturing apparatus can achieve the same operation and effect as those of the above manufacturing method according to the first technique.

Further, a second technique disclosed in the specification relates to a technique for easily providing a powder compact with an intended shape. Specifically, in order to eject a powder compact, which was formed by applying a pressure to powder in a forming chamber, from the forming chamber, the powder compact has to be separated off from an inner surface of the forming chamber. However, since the powder compact was formed by applying a large pressure to the powder, a large frictional force is generated between the powder compact and the inner surface of the forming chamber (specifically, a pressure-receiving surface that receives the forming pressure). Therefore, an attempt to separate the powder compact off from the pressure-receiving surface may cause a part of the powder compact to be torn off and remain on the pressure-receiving surface, failing to provide the powder compact with an intended shape. The second technique disclosed in the specification provides a technique for easily providing the powder compact with an intended shape.

A manufacturing apparatus for a powder compact according to the second technique disclosed in the specification may comprise a forming chamber, a pusher, and an opening/closing device. The forming chamber may comprise an accommodation space capable of accommodating a binder and a powder, an inlet located at one end of the accommodation space, wherein the binder and the powder are supplied through the inlet, and an outlet located at other end of the accommodation space, wherein a powder compact formed by compressing the binder and the powder is ejected through the outlet. The pusher may be movable into and out of the forming chamber through the inlet, wherein the pusher may compress the binder and the powder accommodated in the accommodation space. The opening/closing device may open and close the outlet and may comprise a door body capable of opening and closing the outlet and a first moving mechanism for moving the door body. The first moving mechanism may move the door body between a closed position where the door body closes the outlet and an open position where the door body opens the outlet. The opening/closing device may be configured to generate a shear force between the door body and the powder compact when the door body moves from the closed position to the open position after the powder compact has been formed.

In the above manufacturing apparatus, the binder and the powder are supplied through the inlet into the forming chamber with the door body at the closed position (i.e., with the outlet closed). Then, the supplied binder and powder are compressed into a powder compact by the pusher moving in and out through the inlet. The outlet is then opened by the door body moving from the closed position to the open position, and the powder compact is ejected through the outlet. At this time, a shear force is generated between the door body which received the forming pressure and the powder compact, and this force facilitates separation of the powder compact from the door body. Therefore, the powder compact can easily have an intended shape.

A third technique disclosed in the specification provides a technique for appropriately supplying a binder and powder into a forming chamber. Specifically, in case a binder is used to solidify powder, the binder and the powder need to be supplied into a forming chamber where the powder is compressed. If the binder and the powder were mixed together in advance and then supplied into the forming chamber, the mixture of the binder and the powder would clog a supply passage, which may result in failure to supply the binder and the powder into the forming chamber. The third technique disclosed in the specification provides a technique for appropriately supplying a binder and powder into a forming chamber.

A manufacturing apparatus for a powder compact according to the third technique disclosed in the specification may comprise a binder supplying device, a powder supplying device, a forming chamber, a moving device, and a pusher. The binder supplying device may comprise a first supply port, wherein the binder supplying device may supply a binder from the first supply port. The powder supplying device may comprise a second supply port located at a position different from a position of the first supply port, wherein the powder supplying device may supply powder from the second supply port. The forming chamber may comprise an inlet, wherein the forming chamber may accommodate the binder and the powder supplied through the inlet. The moving device may be configured to move the forming chamber between a first position where the inlet corresponds to the first supply port and a second position where the inlet corresponds to the second supply port. The pusher may compress the binder and the powder accommodated in the forming chamber into a powder compact.

The above manufacturing apparatus is equipped with the binder supplying device and the powder supplying device, and the binder and the powder are separately supplied into the forming chamber. Thus, the binder and the powder can be supplied into the forming chamber without stagnating in supply passages. Further, although the first supply port of the binder supplying device and the second supply port of the powder supplying device are at different positions, the binder and the powder can be supplied through the same inlet into the forming chamber by the forming chamber moving between the first position and the second position. Thus, the binder and the powder can be appropriately supplied into the forming chamber.

### BRIEF DESCRIPTION OF DRAWINGS

FIG. 1 a diagram illustrating an overall configuration of a manufacturing apparatus according to an embodiment;

FIG. 2 a diagram illustrating a configuration of a powder supplying device;

FIG. 3 a diagram illustrating a configuration of a binder supplying device;

FIG. 4 a diagram illustrating a configuration of a forming unit of a compression device;

FIG. 5 explanatory diagrams for operations of the forming unit of the compression device, where (a) illustrates the state where the forming unit is at a forming position, (b) illustrates the state where the forming unit is at a powder supplying position, (c) illustrates the state where the forming unit is at a powder compact ejecting position, and (d) illustrates the state where the forming unit is at a binder supplying position;

FIG. 6 an explanatory diagram for operation of an opening/closing device provided in the forming unit of the compression device and illustrates the state where a shutter plate is open;

FIG. 7 an explanatory diagram for operation of the opening/closing device provided in the forming unit of the compression device and illustrates the state where the shutter plate is closed;

FIG. 8 a diagram schematically illustrating the state where a binder and powder are supplied in a forming chamber;

FIG. 9 an explanatory diagram for a configuration of a compression mechanism for compressing the binder and powder supplied in the forming chamber (before compression);

FIG. 10 an explanatory diagram for the configuration of the compression mechanism for compressing the binder and powder supplied in the forming chamber (after compression);

FIG. 11 an explanatory diagram for a configuration of a rotation stopper mechanism provided in the compression mechanism;

FIG. 12 an enlarged diagram of the binder and powder compressed in the forming chamber;

FIG. 13 an explanatory diagram for an ejection mechanism for ejecting a powder compact from the forming chamber;

FIG. 14 a diagram schematically illustrating a configuration of a drying device for drying a powder compact;

FIG. 15 an explanatory diagram for a configuration of a recovery device for recovering a dried powder compact;

FIG. 16 an explanatory diagram for operation of the recovery device;

FIG. 17 an explanatory diagram for operation of the recovery device; and

FIG. 18 an explanatory diagram for operation of the recovery device.

### DESCRIPTION OF EMBODIMENTS

Some of the features characteristic to below-described embodiments will herein be listed. It should be noted that the respective technical elements are independent of one another, and are useful solely or in combinations. The combinations thereof are not limited to those described in the claims as originally filed.

In the manufacturing method for a powder compact according to the first technique disclosed in the specification, in the material supplying step, the binder supplying step and the powder supplying step may be performed once or several times alternately to stack a binder layer and a powder layer alternately inside the forming chamber. This configuration facilitates the impregnation of the binder into the powder layer(s), allowing the binder to impregnate throughout the powder in a short time.

In the manufacturing method for a powder compact according to the first technique disclosed in the specification, in the pressure applying step, a first pressure may be applied to the binder layer and the powder layer stacked inside the forming chamber to form the powder compact impregnated with the binder. In this configuration, the powder compact impregnated with the binder is formed by performing the pressure applying step once, allowing for manufacture of the powder compact in a short time.

In the manufacturing method for a powder compact according to the first technique disclosed in the specification, the material supplying step and the pressure applying step may be performed n times alternately (n is an integer of 2 or more). In first to (n−1)-th pressure applying steps, a second pressure may be applied to the binder and the powder supplied in the forming chamber to form a provisional powder compact impregnated with the binder in the forming chamber. A first material supplying step may be performed when the provisional powder compact is not placed in the forming chamber, second to n-th material supplying steps may be performed when the provisional powder compact is placed in the forming chamber. In an n-th pressure applying step, a third pressure may be applied to n−1 provisional powder compacts in the forming chamber and the binder and the powder supplied in the n-th material supplying step to form the powder compact impregnated with the binder, wherein the third pressure is greater than the second pressure. This configuration promotes impregnation of the binder into the powder even when the binder is difficult to impregnate thereinto, allowing for manufacture of a powder compact with a relatively large volume.

The manufacturing method for a powder compact according to the first technique disclosed in the specification may further comprise a heating step of heating the powder compact formed by the pressure applying step. This configuration allows for a reduction in drying time to evaporate moisture contained in the binder within the powder compact, while allowing for an increase in the hardness of the powder compact, thereby improving the handling of the powder compact during recovery.

In the manufacturing apparatus for a powder compact according to the second technique disclosed in the specification, the door body may be movable in a direction perpendicular to an axis of the accommodation space. The door body may move between the closed position and the open position by moving in the direction perpendicular to the axis. This configuration allows for generation of a shear force between the door body and the powder compact using a simple configuration.

In the manufacturing apparatus for a powder compact according to the second technique disclosed in the specification, the door body may be a plate-shaped member comprising a contact surface that contacts an outlet-side end surface of the forming chamber and a non-contact surface opposite to the contact surface. The opening/closing device may further comprise a pressing member contacting the non-contact surface of the door body and a second moving mechanism for moving the pressing member. The second moving mechanism may move the pressing member between a contact position where the pressing member contacts the non-contact surface of the door body at the closed position and a non-contact position where the pressing member does not contact the non-contact surface of the door body at the closed position. The pressing member may be configured to press the door body toward the outlet-side end surface of the forming chamber when the door body moves from the open position to the closed position and the pressing member moves from the non-contact position to the contact position. In this configuration, the forming pressure acting on the door body can be appropriately applied by the door body being pressed by the pressing member.

In the manufacturing apparatus for a powder compact according to the second technique disclosed in the specification, the opening/closing device may further comprise a seal member disposed between the door body and the outlet-side end surface of the forming chamber to provide sealing between the contact surface of the door body and the outlet-side end surface of the forming chamber. This configuration suppresses the binder supplied in the forming chamber from outflowing from the forming chamber.

In the manufacturing apparatus for a powder compact according to the second technique disclosed in the specification, the pusher may be rotatable about the axis within a predetermined angle range. The pusher may be configured to move out of the forming chamber after rotating about the axis when the pusher moves out of the forming chamber after the powder compact has been formed. In this configuration, a shear force is generated between the pusher and the powder compact when the pusher is separated off from the powder compact. This facilitates the separation of the powder compact from the pusher which received the forming pressure, thereby the powder compact can have an intended shape.

In the manufacturing apparatus for a powder compact according to the second technique disclosed in the specification, a clearance may be formed between an inner surface of the accommodation space of the forming chamber and the pusher. This configuration allows air within the powder to escape when the binder and the powder are compressed, promoting the impregnation of the binder into the powder.

In the manufacturing apparatus for a powder compact according to the third technique disclosed in the specification, the moving device may be further configured to move the forming chamber to a third position where the inlet corresponds to the pusher. The pusher may be movable into and out of the forming chamber through the inlet when the forming chamber is moved to the third position by the moving device. In this configuration, a pressure can be applied to the binder and the powder in the forming chamber by the pusher moving into and out of the forming chamber through the inlet through which the powder and the binder are supplied.

In the manufacturing apparatus for a powder compact according to the third technique disclosed in the specification, the forming chamber may further comprise an outlet through which the powder compact is ejected from the forming chamber. The moving device may be further configured to move the forming chamber to a fourth position where the outlet is at a preset position. The powder compact in the forming chamber may be able to be ejected through the outlet when the forming chamber is moved to the fourth position by the moving device. In this configuration, the powder compact can be appropriately ejected through the outlet.

In the manufacturing apparatus for a powder compact according to the third technique disclosed in the specification, the forming chamber may further comprise an accommodation space capable of accommodating the binder and the powder. The inlet may be located at an upper end of the accommodation space. The outlet may be located at a lower end of the accommodation space. In this configuration, a pressure is applied to the binder and the powder supplied through the inlet at the upper end of the accommodation space to form a powder compact, and the compact can be ejected through the outlet at the lower end of the accommodation space. Thus, the powder and the binder are appropriately supplied, and the powder compact can be appropriately ejected.

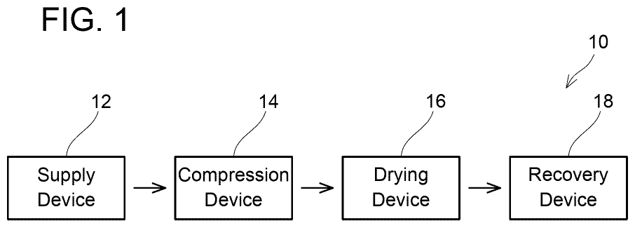

(Embodiment) Referring to the drawings, a manufacturing apparatus 10 for a powder compact according to an embodiment is described. As illustrated in FIG. 1, the manufacturing apparatus 10 comprises a supply device 12 for supplying a binder and powder, a compression device 14 for compressing the supplied binder and powder, a drying device 16 for drying a formed powder compact, and a recovery device 18 for recovering the dried powder compact. Hereinafter, each of the devices 12, 14, 16, and 18 is described.

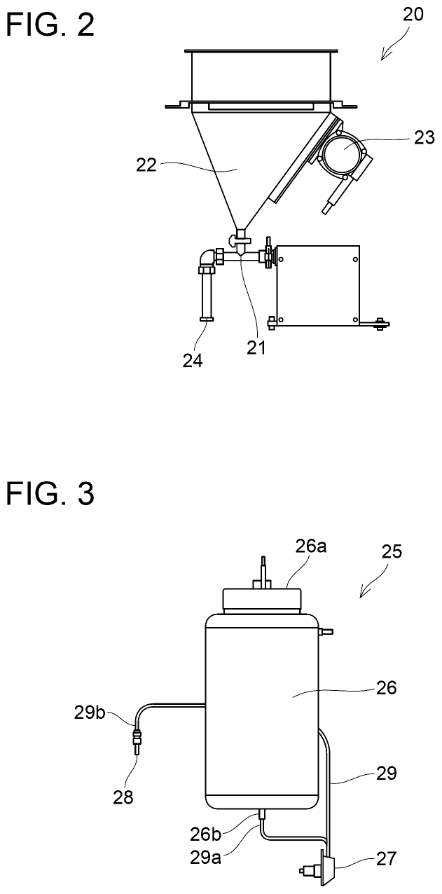

The supply device 12 comprises a powder supplying device 20 for supplying powder (illustrated in FIG. 2) and a binder supplying device 25 for supplying a binder (illustrated in FIG. 3). As illustrated in FIG. 2, the powder supplying device 20 comprises a hopper 22 for temporarily storing the powder and a screw conveyor 21 located at the lower end of the hopper 22.

The hopper 22 has a funnel shape, is open at its upper and lower ends, and temporarily stores the powder therein. The upper-end opening of the hopper 22 serves as an inlet for the powder. The lower-end opening of the hopper 22 serves as an outlet for the powder. The screw conveyor 21 is connected to the lower-end opening of the hopper 22. The powder outflowing from the lower-end opening of the hopper 22 is supplied to the screw conveyor 21. The screw conveyor 21 is driven by a motor, which is not illustrated, and conveys the powder supplied from the hopper 22 to a powder supply port 24. Driving power (i.e., driving speed and driving time) of the motor for the screw conveyor 21 is controlled by a control device, which is not illustrated. The control over the driving power of the motor for the screw conveyor 21 allows the screw conveyor 21 to convey a desired amount (volume) of the powder. The powder supply port 24 is located at the leading end of the screw conveyor 21. The powder conveyed by the screw conveyor 21 flows out from the powder supply port 24. As will be described later, the compression device 14 can be positioned below the powder supply port 24. The powder is supplied from the powder supplying device 20 to the compression device 14 by the screw conveyor 21 being driven while the compression device 14 is positioned below the powder supply port 24.

Moreover, a vibrator 23 is attached to a side surface of the hopper 22. The vibrator 23 vibrates the side surface of the hopper 22 to prevent a bridge of the powder from being formed within the hopper 22. This allows the powder to be stably supplied from the powder supplying device 20 to the compression device 14. That is, if such a bridge of powder is formed within the hopper 22, the powder within the hopper 22 would not outflow from the lower-end opening of the hopper, and thus the powder is not supplied even when the screw conveyor 21 is being driven. In contrast, by the vibrator 23 preventing a bridge of the powder from being formed, the powder stably flows out from the lower end of the hopper 22 to the screw conveyor 21. As a result, the powder can be supplied to the compression device 14 in an amount (volume) corresponding to the driving power of the screw conveyor 21.

It should be noted that examples of the powder treated in the manufacturing apparatus according to this embodiment include, for example, powder dust generated in shot peening treatment (e.g., metal dust and glass dust generated in a factory, paint-containing powder dust generated in infrastructure repair, etc.), resin dust generated in blast treatment performed to peel off coating films, and the like. Such types of powder dust are dried powder dust that does not contain oil nor moisture, and their particles are shaped not to get entangled each other (e.g., granularly shaped). Therefore, a compact cannot be formed simply by applying a pressure to these powder dust. In view of this, in this embodiment, a binder is used to form a powder compact from these powder dust.

Further, the powder treated in the manufacturing apparatus 10 according to this embodiment does not have to have a uniform particle diameter and may be a mixture of powders with large-diameter particles and powder with small-diameter particles. Here, particles with too small diameters may hinder impregnation of the binder, and particles with too large diameters may cause a failure to hold the binder between the particles. Therefore, in order to stably form a powder dust compact, it is preferable to make adjustment such that particles with suitable diameters are contained in high proportion. Specifically, it is preferable to make adjustment such that a ratio of the density of major component of the powder to the bulk density of the powder is 3.0 or more.

As illustrated in FIG. 3, the binder supplying device 25 comprises a storage tank 26 for temporarily storing the binder and a tube pump 27 connected to the storage tank 26. A binder supply port 26a is located at the upper end of the storage tank 26 and a binder discharge port 26b is located at the lower end thereof. The binder is supplied through the binder supply port 26a into the storage tank 26, and the binder in the storage tank flows out through the binder discharge port 26b. A supply pipe inlet 29a of a supply pipe 29 is connected to the binder discharge port 26b, and a binder supply port 28 is located at a supply pipe outlet 29b of the supply pipe 29. The tube pump 27 is located between the supply pipe inlet 29a and the supply pipe outlet 29b of the supply pipe 29.

The tube pump 27 presses and deforms an elastic tube by a rotating roller to suction the binder in the storage tank 26 into the tube pump 27 and discharge the binder within the tube pump 27 toward the binder supply port 28. Driving power (i.e., driving speed and driving time) of the roller in the tube pump 27 is controlled by a control device, which is not illustrated. The control over the driving power of the roller in the tube pump 27 allows the tube pump 27 to discharge a desired amount (volume) of the binder.

The tube pump 27 is free of mechanical components (e.g., an impeller, etc.) located on a binder delivery passage (i.e., inside the tube). This prevents occurrence of stoppage and failure of the pump caused by adhesion of the binder to the binder delivery passage. Further, when the tube pump 27 needs maintenance, the maintenance can be done simply by replacing the tube. In this embodiment, the tube pump 27 is used to deliver the binder, but a pump other than the tube pump (e.g., a diaphragm pump, etc.) may be used instead.

After discharged from the tube pump 27, the binder is supplied (fed) into the compression device 14 through the binder supply port 28 located at the supply pipe outlet 29b of the supply pipe 29. As will be described later, the compression device 14 can be positioned below the binder supply port 28. The binder is supplied from the binder supplying device 25 to the compression device 14 by the tube pump 27 being driven while the compression device 14 is positioned below the binder supply port 28. In this embodiment, the binder supply port 28 is located at a position different from the position of the powder supply port 24. For this reason, the compression device 14 is movable between the powder supply port 24 and the binder supply port 28.

It should be noted that the binder used in this embodiment may be, for example, silicate soda (i.e., liquid glass). Silicate soda (the binder) is dissolved in water for use, and its viscosity is adjusted by adjusting the amount of water. Specifically, the viscosity of the binder is adjusted depending on characteristics of the powder (e.g., the density of major component/bulk density of the powder). The adjustment of the binder viscosity depending on characteristics of the powder facilitates impregnation of the binder throughout the powder when the binder and the powder are compressed in the compression device 14. That is, a binder with too high viscosity does not permeate throughout the powder when compressed, and consequently, the binder locally pools and the powder remains partially unimpregnated with the binder, which results in a failure to shape the powder into a desired shape. Conversely, a binder with too low viscosity can permeate throughout the powder when compressed, but the powder cannot maintain a desired shape. The adjustment of the binder viscosity depending on characteristics of the powder allows the binder to permeate throughout the powder, while allowing a desired shape to be maintained after compression.

As described above, in the manufacturing apparatus 10 according to this embodiment, the powder and the binder are separately supplied (fed) into the compression device 14 by the powder supplying device 20 and the binder supplying device 25. Thus, an amount (volume) of the powder to be supplied by the powder supplying device 20 and an amount (volume) of the binder to be supplied by the binder supplying device 25 both can be adjusted to desired amounts. This allows for impregnation of the binder throughout the powder to shape the powder into a desired shape, while preventing softening of a powder compact due to too much binder therein and achieving desired strength. That is, when the amount of binder is too small relative to the amount of powder, the binder does not permeate throughout the powder, resulting in a failure to form a desired shape. Conversely, when the amount of binder is too large relative to the amount of powder, a resulting powder compact is soft and has decreased mechanical strength. Finely adjusting both the amounts of powder and binder can provide both formability and mechanical strength of a powder compact.

Further, in the manufacturing apparatus 10 according to this embodiment, the powder supply port 24 and the binder supply port 28 are located at different positions, and the powder supply passage in the powder supplying device 20 and the binder supply passage in the binder supplying device 25 are separated. This allows for fine adjustment of a powder amount to be supplied. That is, if a single supply passage were used as the powder supply passage and the binder supply passage, a supply amount of the powder would be reduced due to the binder adhering to the supply passage. Separating the powder supply passage from the binder supply passage prevents such a reduction in the supply amount of the powder due to the binder adhesion and allows for fine adjustment of the supply amount of powder.

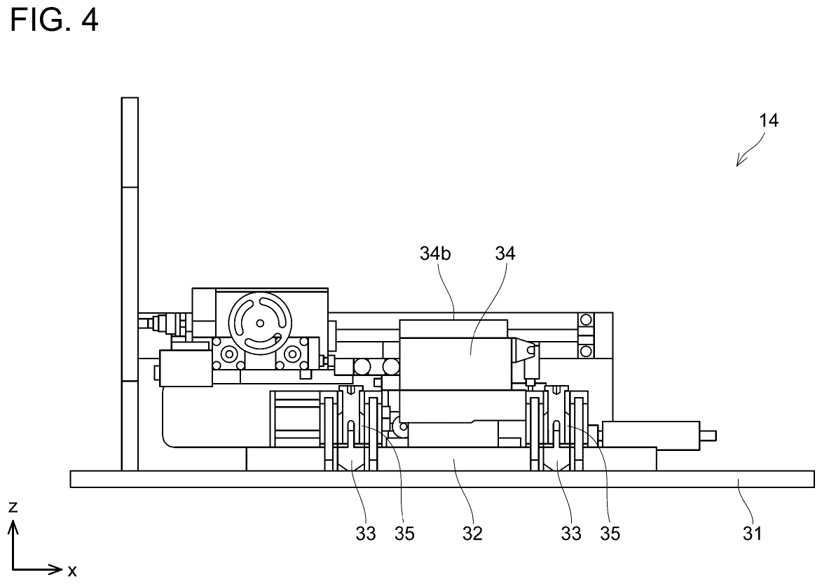

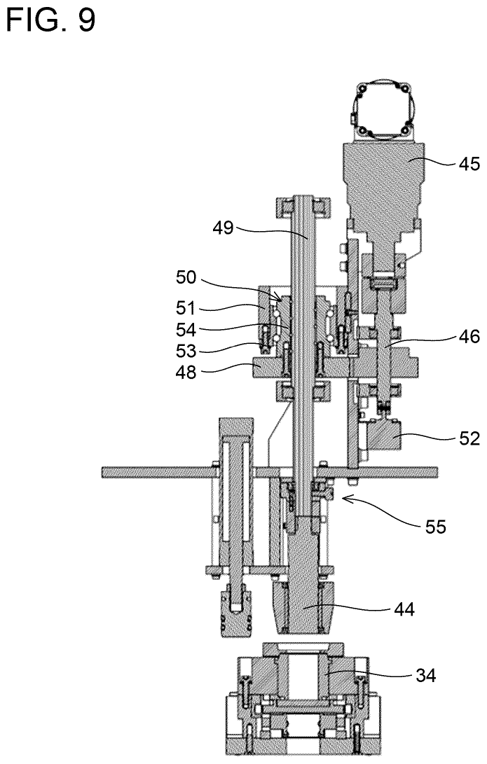

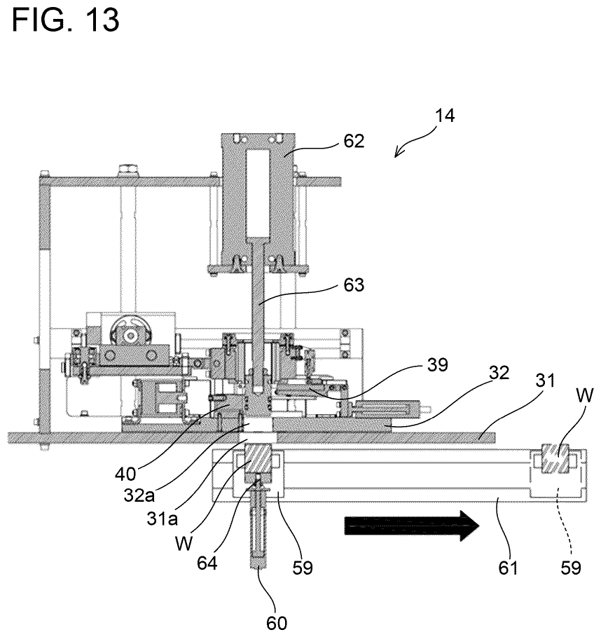

Now, the compression device 14 is described. The compression device 14 comprises a forming unit to which the powder and the binder are supplied from the powder supplying device 20 and the binder supplying device 25 (illustrated in FIGS. 4 to 7), a compression mechanism for compressing the powder and the binder supplied in the forming unit (illustrated in FIGS. 9 to 11), and an ejection mechanism for ejecting a powder compact formed in the forming unit (illustrated in FIG. 13). Hereinafter, each of the forming unit, the compression mechanism, and the ejection mechanism is described.

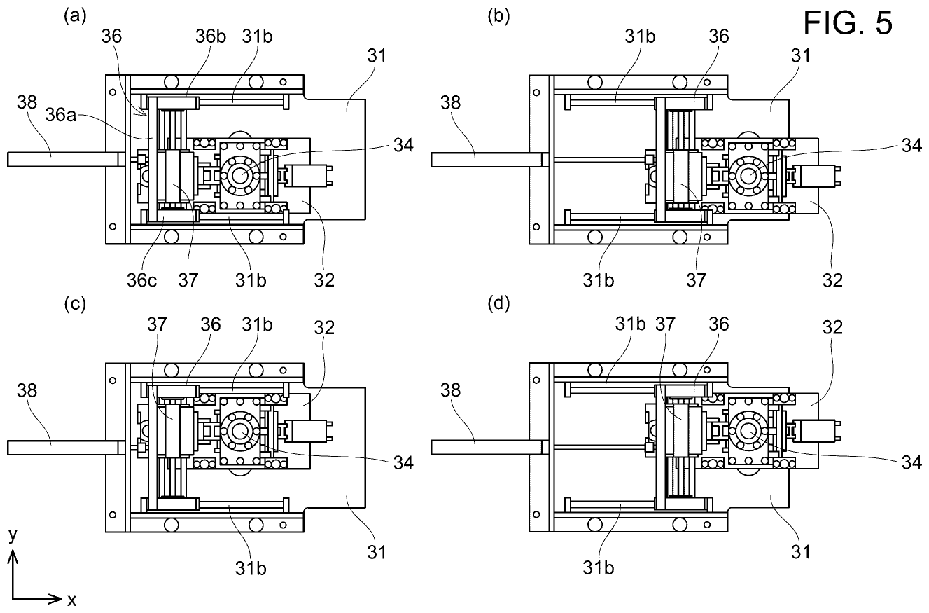

As illustrated in FIGS. 4 and 5, the forming unit comprises a body frame 31, a base 32 located on the body frame 31, a moving mechanism (37, 38, etc.) for moving the base 32 in an X direction and a Y direction relative to the body frame 31, and a forming chamber 34 located on the base 32. The body frame 31 has a substantially rectangular shape when seen in a plan view. An outlet 31a (see FIG. 13) is defined in the body frame 31 to eject a powder compact W formed in the forming chamber 34.

The base 32 is movably supported on the upper surface of the body frame 31. The base 32 is a plate member having a substantially rectangular shape when seen in a plan view and has a smaller area than the body frame 31 when seen in the plan view. That is, the dimension of the base 32 in the X direction is smaller than the dimension of the body frame 31 in the X direction, and the dimension of the base 32 in the Y direction is smaller than the dimension of the body frame 31 in the Y direction. Thus, the base 32 is movable in the X direction and the Y direction on the body frame 31. Therefore, the base 32 can move to a position for compression of the powder and the binder supplied in the forming chamber 34 (the position in FIG. 5(a)), a position for supply of the powder into the forming chamber 34 (the position in FIG. 5(b)), a position for supply of the binder into the forming chamber 34 (the position in FIG. 5(d)), and a position for ejection of the powder compact W from the forming chamber 34 (the position in FIG. 5(c)). Accordingly, the above-described powder supply port 24 of the powder supplying device 20 is located above the forming chamber 34 illustrated in FIG. 5(b). Further, the above-described binder supply port 28 of the binder supplying device 25 is located above the forming chamber 34 illustrated in FIG. 5(d). The compression mechanism (illustrated in FIGS. 9 to 11) is located above the forming chamber 34 illustrated in FIG. 5(a). The ejection mechanism (illustrated in FIG. 13) is located above the forming chamber 34 illustrated in FIG. 5(c). Moreover, an outlet 32a (see FIG. 13) is defined in the base 32 to eject the powder compact W formed in the forming chamber 34.

Now, the moving mechanism (37, 38, etc.) for moving the base 32 relative to the body frame 31 is described. As illustrated in FIG. 5, the moving mechanism comprises a slider 36 guided along a pair of guides 31b, an X-direction air cylinder 38 for moving the slider 36, and a Y-direction air cylinder 37 attached to the slider 36. The pair of guides 31b is fixed to the body frame 31 and extends in the X direction along a pair of sides of the body frame 31 which extend in the X direction. The slider 36 comprises a support portion 36b guided by one of the pair of guides 31b, a support portion 36c guided by the other of the pair of guides 31b, and a body portion 36a connected to the support portions 36b, 36c. The slider 36 is movable in the X direction along the guides 31b. The leading end of a rod of the X-direction air cylinder 38 is fixed to the body portion 36a of the slider 36. A cylinder body of the X-direction air cylinder 38 is fixed to the body frame 31. Thus, the slider 36 can move in the X direction along the guides 31b by the X-direction air cylinder 38 reciprocating its rod. The Y-direction air cylinder 37 is located between the pair of support portions 36b, 36c of the slider 36. The Y-direction air cylinder 37 is a double-rod air cylinder, where one of the rods is fixed to the support portion 36b of the slider 36 and the other rod is fixed to the other support portion 36c of the slider 36. Thus, a cylinder body of the Y-direction air cylinder 37 moves in the Y direction by driving the Y-direction air cylinder 37. The base 32 is fixed to the cylinder body of the Y-direction air cylinder 37. Thus, the base 32 moves in the Y-direction as the cylinder body of the Y-direction air cylinder 37 moves in the Y direction. Accordingly, the base 32 can be moved to a desired position (i.e., the position illustrated in FIG. 5(a), (b), (c), or (d)) by driving the X-direction air cylinder 38 and the Y-direction air cylinder 37.

As described above, the forming chamber 34 is fixed to the base 32 and the base 32 moves on the upper surface of the body frame 31. A large frictional force between the base 32 and the body frame 31 hinders smooth movement of the base 32. Especially, the powder scattered over the upper surface of the body frame 31 increases the frictional force between the base 32 and the body frame 31, making it difficult for the base 32 to move. In view of this, as illustrated in FIG. 4, the forming chamber 34 is supported by a plurality of free bearings 33 (four free bearings 33 in this embodiment (two are illustrated in FIG. 4)) in this embodiment. Each free bearing 33 preferably comprises a structure with a powder discharging function (i.e., a bearing with a dust discharge hole) and is fixed to the base 32 via a compression spring 35. A large force toward the body frame 31 does not act on the forming chamber 34, except during the formation of a powder compact W in the forming chamber 34. Thus, the base 32 is lifted by the compression springs 35 and there is a space between the base 32 and the body frame 31. This reduces the frictional force between the base 32 and the body frame 31, allowing the base 32 to be moved with a small force on the body frame 31. In contrast, a large force acts on the forming chamber 34 during the formation of a powder compact W in the forming chamber 34. When the pressure applied to the forming chamber 34 exceeds the spring force of the compression springs 35, the base 32 lowers and comes into contact with the body frame 31. Thus, the maximum pressure applied to the forming chamber during the formation of a powder compact W is received not by the free bearings 33 but by the base 32. This prevents occurrence of problems such as deformation of the upper surface of the body frame 31 caused by the free bearings 33.

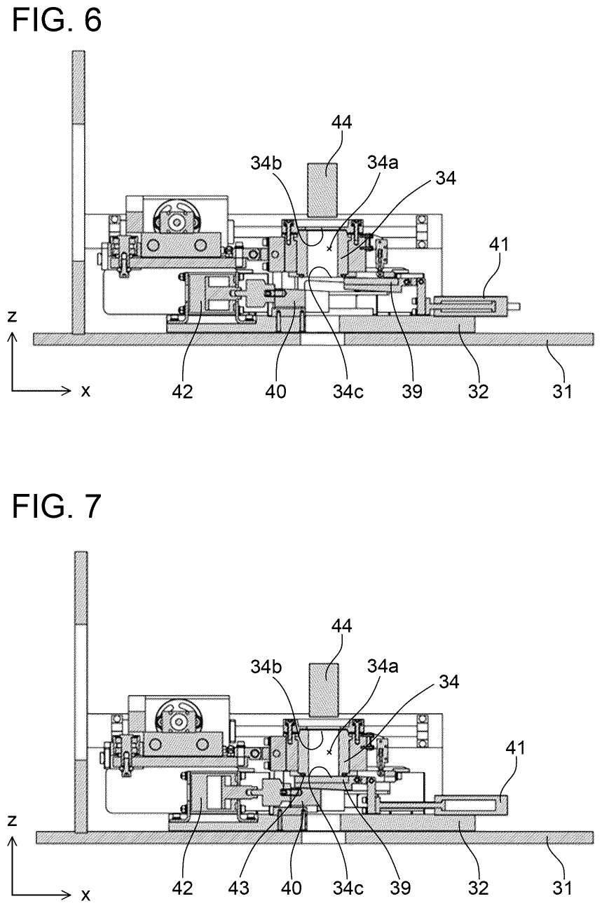

Now, the forming chamber 34 is described. As illustrated in FIGS. 6 and 7, the forming chamber 34 is a cylindrical member and defines therein an accommodation space 34a for accommodating the binder and the powder. An inlet 34b is defined at the upper end of the accommodation space 34a, and an outlet 34c is defined at the lower end of the accommodation space 34a. The inlet 34a functions as an inlet through which the binder and the powder are supplied. The outlet 34c functions as an outlet through which a powder compact W is ejected from the forming chamber 34. Thus, the forming chamber 34 is positioned relative to the base 32 such that the outlet 34c is positioned above the outlet 32a of the base 32. This allows the powder compact W to be ejected, through the outlet 34c, the outlet 32a of the base 32 and the outlet 31a of the body frame 31, to the outside of the compression device 14.

As described above, the outlet 34c is located at the lower end of the forming chamber 34. The outlet 34c of the forming chamber 34 needs to be closed to accommodate the binder and the powder in the accommodation space 34a of the forming chamber 34. In this embodiment, a shutter device is provided to open and close the outlet 34c of the forming chamber 34. The shutter device is located between the base 32 and the forming chamber 34. The shutter device comprises a shutter plate 39, a press plate 40 located below the shutter plate 39, an air cylinder 41 for moving the shutter plate 39, and an air cylinder 42 for moving the press plate 40.

The shutter plate 39 is a plate-shaped member having a larger plane area than the outlet 34c. The shutter plate 39 is movable in a direction perpendicular to an axial direction of the forming chamber 34 (i.e., a vertical direction) (i.e., movable in a horizontal direction). The shutter plate 39 is moved by the air cylinder 41 to a position where the shutter plate 39 opens the outlet 34c (the position illustrated in FIG. 6) and to a position where the shutter plate 39 closes the outlet 34c (the position illustrated in FIG. 7). When the outlet 34c is closed by the shutter plate 34, the binder and the powder contact the upper surface of the shutter plate 34.

The press plate 40 is a plate-shaped member having a smaller plane area than the shutter plate 39 (specifically, the dimension in the X direction is approximately ½ of that of the shutter plate 39, and the dimension in the Y direction is substantially the same as that of the shutter plate 39 (see FIG. 6)). In contrast, the thickness of the press plate 40 is larger than the thickness (the dimension in a Z direction) of the shutter plate 39. Thus, the mechanical strength of the press plate 40 is higher than the mechanical strength of the shutter plate 39. Similar to the shutter plate 39, the press plate 40 is movable in the direction perpendicular to the axial direction of the forming chamber 34 (i.e., the vertical direction) (i.e., movable in the horizontal direction). The press plate 40 is moved by the air cylinder 42 to a position where the press plate 40 contacts the lower surface of the shutter plate 39 at the position for closing the outlet 34c (the position illustrated in FIG. 7) and to a position where the press plate 40 is unable to contact the lower surface of the shutter plate 39 (the position illustrated in FIG. 6).

As illustrated in FIG. 6, when the shutter plate 39 is at the position for opening the outlet 34c and the press plate 40 is at the position of being unable to contact the lower surface of the shutter plate 39, the shutter plate 39 and the press plate 40 face each other with the outlet 34c of the forming chamber 34 interposed therebetween. As apparent from FIGS. 6 to 8, the upper surface of the shutter plate 39 is a horizontal surface perpendicular to the axial direction of the forming chamber 34, while the lower surface of the shutter plate 39 is an inclined surface slightly inclined with respect to the upper surface of the shutter plate 39. Specifically, the lower surface of the shutter plate 39 is linearly inclined upward toward the press plate 40. In other words, the lower surface of the shutter plate 39 is inclined such that the thickness of the shutter plate 39 is reduced toward the press plate 40. The lower surface of the press plate 40 is a horizontal surface perpendicular to the axial direction of the forming chamber 34, while the upper surface of the press plate 40 is linearly inclined downward toward the shutter plate 39. That is, the upper surface of the press plate 40 is inclined such that the thickness of the press plate 40 is reduced toward the shutter plate 39.

Here, the lower surface angle of the shutter plate 39 and the upper surface angle of the press plate 40 are adjusted such that the press plate 40 presses the shutter plate 39 toward the end surface of the forming chamber 34 when the shutter plate 39 and the press plate 40 are at the positions illustrated in FIG. 7. That is, as the press plate 40 moves to the position of contacting the lower surface of the shutter plate 39 at the position for closing the outlet 34c (i.e., moves to the position illustrated in FIG. 7), the press plate 40 enters between the lower surface of the shutter plate 39 and the upper surface of the base 32 like a wedge. As a result, the shutter plate 39 is pressed against the lower end surface of the forming chamber 34. A seal member 43 (see FIG. 7) is located at the lower end surface of the forming chamber 34, and the shutter plate 39 presses the seal member 43. This provides sealing to spacing between the lower end surface of the forming chamber 34 and the shutter plate 39, appropriately suppressing the binder in the accommodation space 34a from outflowing from the accommodation space 34a. Further, the compression force during the formation of powder compact W can be appropriately received by the shutter plate 39.

Now, a compression mechanism for compressing the powder and the binder supplied in the forming chamber 34 is described. As illustrated in FIGS. 9 to 11, the compression mechanism comprises a pusher member 44, a motor 45 for driving the pusher member 44, and a conversion mechanism (46, 47, 48, 49, 50, etc.) for converting the rotational motion of the motor 45 to a reciprocating motion of the pusher member 44.

The pusher member 44 is a cylindrical member and has an outer shape corresponding to the shape of the accommodation space 34a of the forming chamber 34. The outer diameter of the pusher member 44 is slightly smaller than the inner diameter of the accommodation space 34a. Thus, when the pusher member 44 is inserted in the accommodation space 34a, a void (a clearance) is formed between the pusher member 44 and the inner surface of the accommodation space 34a. For example, the size of this clearance is between 0.05 and 0.1 mm. The clearance allows air contained in the binder and the powder to escape to the outside of the forming chamber 34 when the binder and the powder are compressed by the pusher member 44. This facilitates impregnation of the binder throughout the powder. Further, an increase in frictional force due to the powder adhering to the inner surface of the accommodation space 34a can be suppressed, thereby allowing for reciprocation of the pusher member 44 with a smaller force.

The conversion mechanism (46, 47, 48, 49, 50, etc.) comprises a rotation shaft 46 coupled to the output shaft of the motor 45, gears 47, 48 for transmitting the rotation of the rotation shaft 46, a nut 50 to which rotation is transmitted via the gears 47, 48, and a ball screw 49 screwed with the nut 50.

One end of the rotation shaft 46 is connected to the output shaft of the motor 45, and the opposite end of the rotation shaft 46 is connected to an encoder 52. The encoder 52 detects the rotation amount of the rotation shaft 46. In this embodiment, the pusher member 44 is stopped at a predetermined position in the forming chamber 34 (the accommodation space 34a) by driving the motor 45 based on the rotation amount of the rotation shaft 46 which is detected by the encoder 52. This allows for application of an appropriate compression force onto the binder and the powder, thereby forming a powder compact W having desired mechanical strength.

The movement speed of the pusher member 44 may be controlled by adjusting the rotational speed of the motor 45 based on the detection result by the encoder 52. For example, the movement speed of the pusher member 44 is controlled based on characteristics of the powder (e.g., its particle size, bulk density, etc.) and the viscosity of the binder. This allows the binder to impregnate into the powder at an appropriate rate, facilitating impregnation of the binder throughout the powder.

In the embodiment above, the encoder 52 is connected to the rotation shaft 46, however, this need not always be the case. For example, a servomotor may be used as the motor 45 and the rotation amount of the motor 45 may be detected by an encoder of the servomotor. In this case, the pusher member 44 can be stopped at a desired position by stopping the motor based on the rotation amount of the motor.

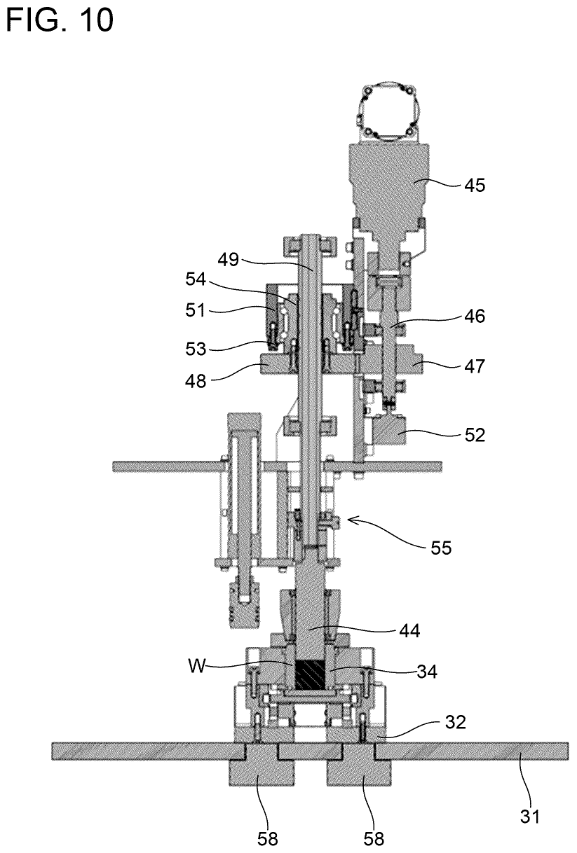

Alternatively, as illustrated in FIG. 10, a load cell 58 may be located on the body frame 31 and a compression force applied in the forming chamber 34 may be detected by the load cell 58. Then, the motor 45 may be stopped when the compression force reaches a set value. These configurations also allow for formation of a powder compact W with an appropriate compression force.

The gear 47 is fixed to the rotation shaft 46 and meshed with the gear 48. The nut 50 is attached to the gear 48 and screwed with the ball screw 49. The nut 50 is configured to receive a radial load due to the rotation of the nut 50 and a thrust load due to an axial force of the ball screw 49 (i.e., a compression force applied during the formation of a powder compact W by the pusher member 44). Specifically, a flange 53 on thrust load-receiving bearing side is fixed to a base 51 (fixed to the body frame 31), a flange 54 on radial load-receiving flange side is fixed to the gear 48, and the nut 50 is configured to rotate at a fixed position. A rotation stopper mechanism 55 is located on the ball screw 49, and therefore the ball screw 49 can rotate only within a predetermined angle range. Limiting the rotation of the ball screw 49 by the rotation stopper mechanism 55 causes the ball screw 49 to move in a reciprocating manner in an up-down direction. The pusher member 44 is attached to the leading end of the ball screw 49. Thus, the pusher member 44 moves into and out of the forming chamber 34 with the reciprocation of the ball screw 49, so that the binder and the powder in the forming chamber 34 can be compressed.

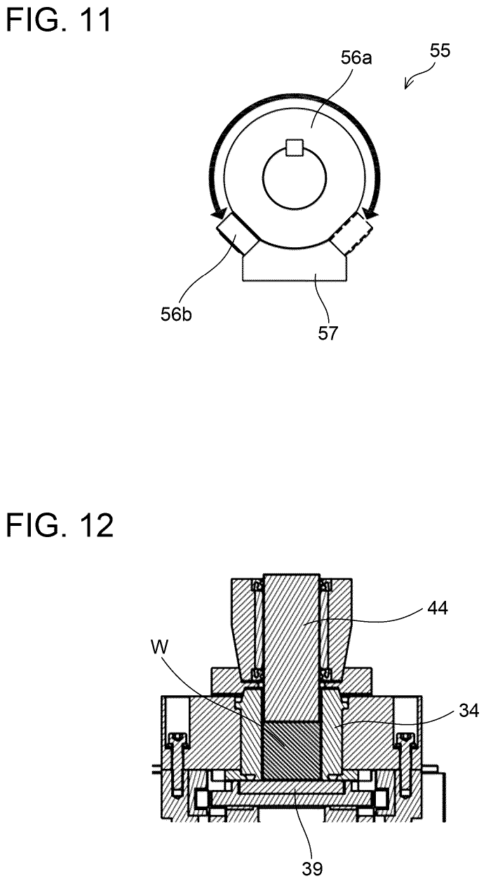

Now, the above-mentioned rotation stopper mechanism 55 is described. As illustrated in FIG. 11, the rotation stopper mechanism 55 comprises a flange 56a attached to the outer surface of the ball screw 49, a projection 56b projecting from the outer surface of the flange 56a, and a rotation stopper 57 located on the outer surface of the flange 56a. The flange 56a is a disk-shaped member and rotates integrally with the ball screw 49. The projection 56b is located at a position on the circumference of the flange 56a and rotates integrally with the flange 56a (i.e., the ball screw 49). The rotation stopper 57 is a separate component from the flange 56a and fixed to the body frame 31. Thus, the rotation stopper 57 does not rotate with the rotation of the ball screw 49. The rotation stopper 57 includes a surface to which the projection 56b contacts from the left (the surface in contact with the solid-line projection 56b in FIG. 11) and a surface to which the project 56b contacts from the right (the surface in contact with the broken-line projection 56b in FIG. 11). Thus, while the projection 56b does not contact the rotation stopper 57, the ball screw 49 can rotate with the rotation of the nut 50. In contrast, once the projection 56b contacts the rotation stopper 57, the rotation of the ball screw 49 is limited and the ball screw 49 starts reciprocation with further rotation of the nut 50.

Now, an ejection mechanism for ejecting a powder compact W formed in the forming chamber 34 is described. As illustrated in FIG. 13, the ejection mechanism comprises an ejecting air cylinder 62 located above the forming chamber 34 and a holding air cylinder 60 located below the forming chamber 34. The ejecting air cylinder 62 comprises a rod 63. The rod 63 is reciprocated by the ejecting air cylinder 62. The holding air cylinder 60 comprises a rod 64 and a receiver is located at the leading end of the rod 64. The rod 64 is reciprocated by the holding air cylinder 60. The holding air cylinder 60 is attached to a holder 59. The holder 59 can be moved by a guide unit 61 between a position for receiving a powder compact W ejected from the forming chamber 34 (the solid-line position in FIG. 13) and a position for handing over the powder compact W to the drying device 16 (the broken-line position in FIG. 13).

To eject a powder compact W formed in the forming chamber 34, the holder 59 is first moved to the position for receiving the powder compact W (the solid-line position in FIG. 13). Then, the rod 64 of the holding air cylinder 60 is extended to move the receiver at the leading end of the rod 64 to immediately below the outlet 34c of the forming chamber 34. Next, the shutter device is actuated to open the outlet 34c of the forming chamber 34, and the ejecting air cylinder 62 is actuated to extend the rod 63 so that the leading end of the rod 63 pushes out the powder compact W downward. Thus, the powder compact W is ejected from the forming chamber 34 and the powder compact W is received by the leading end of the rod 64 of the holding air cylinder 60. Then, the rod 64 of the holding air cylinder 60 is contracted to move the powder compact W downward. The guide unit 61 is then actuated to convey the powder compact W to the drying device 16.

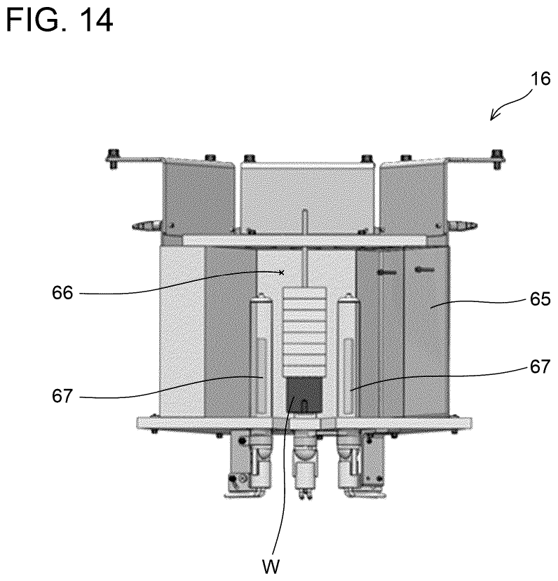

Now, the drying device 16 for drying a powder compact W is described. As shown in FIG. 14, the drying device 16 comprises a furnace body 65 and a plurality of heaters 67 located in a treatment space 66 of the furnace body 65. A powder compact W is placed centrally in the treatment space 66. The heaters 67 surround the powder compact W placed in the treatment space 66. In this embodiment, the heaters 67 surround the powder compact W at four positions (at 90-degree intervals along circumference). However, the number of the heaters 67 is not limited to four, and the number may be, for example, four or more. Further, the furnace body 65 comprises an air inlet for introducing the outside air into the treatment space 66 (not illustrated) and an air outlet for exhausting the air in the treatment space 66 (not illustrated). For example, the air inlet may be formed in a bottom wall of the furnace body 65 and the air outlet may be formed in a ceiling wall of the furnace body 65. An exhaust device may be located at the air outlet and the air in the treatment space 66 may be thereby exhausted forcibly. For example, a motor-driven exhaust fan or an ejector device using compressed air may be used as the exhaust device. Use of the ejector device allows the temperature of exhausted air to be held low.

To dry a powder compact W by the above-described drying device 16, a powder compact W is first placed within the treatment space 66 of the furnace body 65. Then, the powder compact W is heated from outside by the heaters 67. Thus, the surface of the powder compact W is heated with the radiation heat from the heaters 67, thereby removing moisture from the powder compact W. Here, the amount of moisture removed by the drying device 16 may be, for example, 20 to 50% of moisture contained in the powder compact W. After a desired amount of moisture is removed from the powder compact W, the powder compact W is recovered by the recovery device 18.

During the drying of the powder compact W, air is introduced from the outside of the furnace body 65 into the treatment space 66 through the air inlet and the air in the treatment space 66 is exhausted to the outside of the furnace body 65 through the air outlet. Thus, the air flows in the treatment space 66 of the furnace body 65, which facilitates the removal of moisture from the powder compact W.

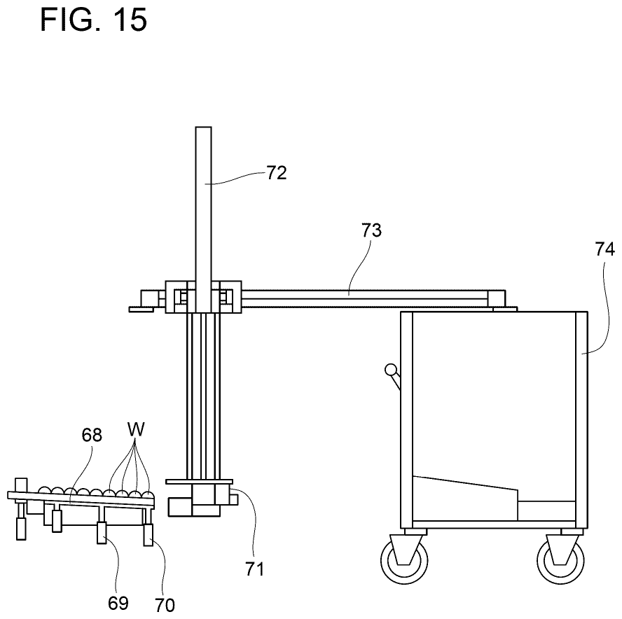

Now, the recovery device 18 for recovering a powder compact W dried by the drying device 16 is described. As illustrated in FIG. 15, the recovery device 18 comprises a cooling trough 68 for conveying powder compacts W and a conveyor device (71, 72, 73) for conveying the powder compacts W conveyed by the cooling trough 68 to a recovery container 74.

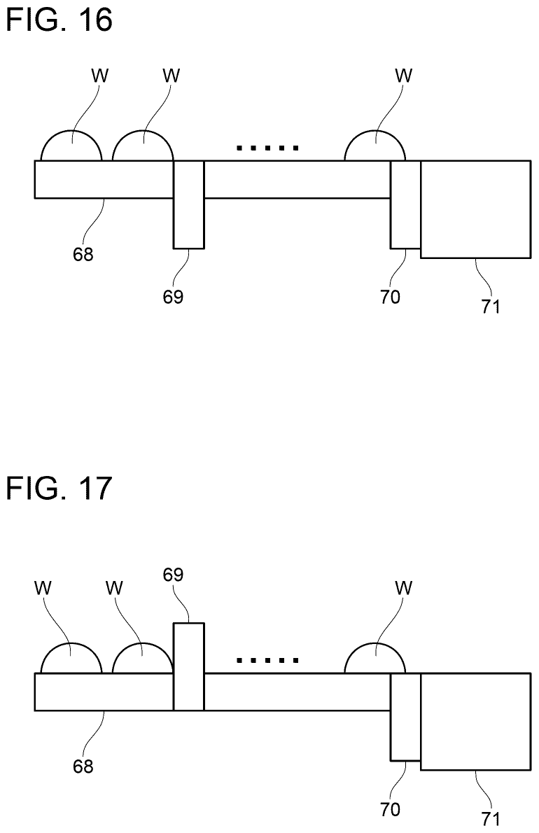

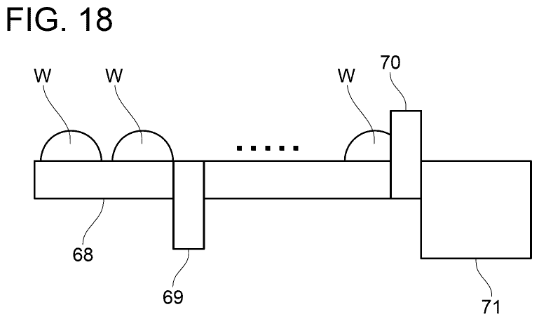

As illustrated in FIGS. 15 to 18, multiple powder compacts W can be placed on the cooling trough 68. That is, the cooling trough 38 has a length to ensure a desired time to cool the powder compacts W dried by the drying device 16. Thus, multiple powder compacts W are placed on the cooling trough 68. Further, a plurality of stoppers 69, 70 is located on the cooling trough 38 and how the powder compacts W are conveyed can be adjusted by the stoppers 69, 70. For example, in the state illustrated in FIG. 16, the stoppers 69, 70 are both moved downward and thus the powder compacts W on the cooling trough 68 are rapidly conveyed to the recovery container 74. In contrast, in the state illustrated in FIG. 17, the stopper 69 is moved upward and the stopper 70 remains down. Thus, only the powder compacts W located between the stopper 69 and the stopper 70 are conveyed to the recovery container 74. Further, in the state illustrated in FIG. 18, the stopper 69 is moved downward and the stopper 70 is moved upward. Thus, the powder compacts W on the cooling trough 68 are not conveyed to the recovery container 74 and remain on the cooling trough 68. Thus, the powder compacts W can be sufficiently cooled.

The conveyor device (71, 72, 73) comprises a conveyor portion 71 on which a powder compact W is placed, a drive device 72 for moving the conveyor portion 71 in the up-down direction, and a conveyor device 73 for conveying the powder compact W, which was moved to the upper end by the drive device 72, in a horizontal direction. Thus, the powder compacts W conveyed on the cooling trough 68 are recovered by the recovery device 18 into the recovery container 74. Since the powder compacts W recovered into the recovery container 74 have a desired shape and increased mechanical strength, they can be easily handled thereafter. In order to efficiently cool the powder compacts W, a cooling device that blows air toward the powder compacts W on the cooling trough 68 may be provided. For example, the air in the drying device 16 may be suctioned and exhausted by the ejector device and this exhausted air may be used to cool the powder compacts W. This configuration allows the powder compacts W to be efficiently cooled without requiring additional equipment.

A procedure for manufacturing a powder compact W using the above-described manufacturing apparatus 10 is described. First, the outlet 34c of the forming chamber 34 is closed by the shutter device and the base 32 is positioned at the position for supplying the binder (the position illustrated in FIG. 5(d)). Then, the binder supply device 25 is actuated to supply a predetermined amount of binder into the forming chamber 34. After the binder is supplied into the forming chamber 34, the base 32 is moved to the position for supplying the powder (the position illustrated in FIG. 5(b)). After the base 32 is positioned at the position illustrated in FIG. 5(b), the powder supply device 20 is actuated to supply a predetermined amount of powder into the forming chamber 34. Since the powder and the binder are supplied into the forming chamber 34 via separate supply passages, the binder and the powder can be supplied in the forming chamber 34 at a desired ratio. Further, since the binder and the powder are supplied separately, a binder layer and a powder layer are stacked in the forming chamber 34.

Then, the base 32 is moved to the position for compressing the powder and the binder in the forming chamber 34 (the position illustrated in FIG. 5(a)), and then the compression device is actuated. As a result, the pusher member 44 is lowered toward the forming chamber 34 and inserted into the forming chamber 34. The binder layer and the powder layer in the forming chamber 34 are thereby compressed, causing the binder layer to impregnate throughout the powder layer. As a result of the pusher member 44 being further lowered, a powder compact W in which the binder has impregnated throughout the powder layer is formed (the state illustrated in FIG. 12).

After the powder compact W is formed, the pusher member 44 is actuated to raise. Once the pusher member 44 is actuated, the pusher member 44 first rotates about its axis until the rotation about the axis is stopped by the rotation stopper mechanism 55 and then starts raising. The rotation of the pusher member 44 about the axis generates a shear force between the leading end surface of the pusher member 44 and the powder compact W, which separates the surface of the pusher member 44 from the powder compact W. If the pusher member 44 rose without rotating about the axis, a part of the powder compact W could be peeled off from the powder compact W and remain on the surface of the pusher member 44. In this embodiment, since the pusher member 44 rotates about the axis before starting to raise, a shear force is generated between the pusher member 44 and the powder compact W, separating the surface of the pusher member 44 from the powder compact W. Therefore, it is possible to avoid a part of the powder compact W adhering to and remaining on the surface of the pusher member 44.

After the pusher member 44 raises and moves out of the forming chamber 34, the base 32 is moved to the position for ejecting the powder compact W from the forming chamber 34 (the position illustrated in FIG. 5(c)). After the base 32 is moved to the position illustrated in FIG. 5(c), the shutter device opens the outlet 34c of the forming chamber 34. At this time, a shear force is generated between the shutter plate 39 and the powder compact W since the shutter plate 39 moves in the horizontal direction (i.e., a direction perpendicular to the axis of the forming chamber 34). Thus, the powder compact W is separated from the surface of the shutter plate 39, avoiding a part of the powder compact W remaining on the surface of the shutter plate.

After the shutter device opens the outlet 34c of the forming chamber 34, the ejection mechanism is actuated to eject the powder compact W in the forming chamber 34 from the compression device 14. After ejected from the compression device 14, the powder compact W is dried by the drying device 16. After dried by the drying device 16, the powder compact W is recovered by the recovery device 18.

As clear from the above description, in the manufacturing apparatus according to the embodiment, the binder and the powder are supplied separately into the forming chamber 34. Thus, occurrence of problems in the supply passage through which the binder is supplied to the forming chamber 34 and the supply passage through which the powder is supplied to the forming chamber 34 can be prevented. Further, since a desired amount (volume) of the powder and a desired amount (volume) of the binder can be supplied to the forming chamber 34, an appropriate amount of the binder can permeate throughout the powder, providing the powder compact W with an intended shape. Moreover, the powder compact W can have desired mechanical strength, which facilitates handling of the powder compact W.

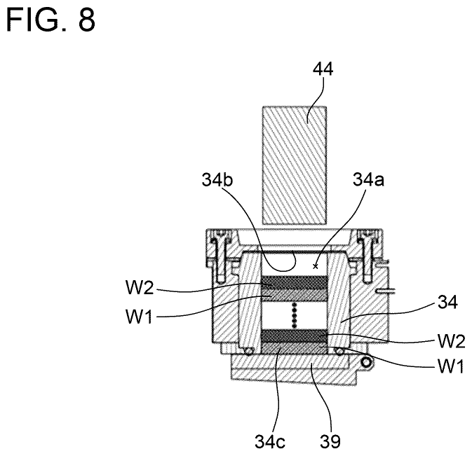

In the embodiment above, the binder is supplied into the forming chamber 34 once, the powder is supplied into the forming chamber 34 once, and then the binder and the powder are compressed to form a powder compact W, however, the technology disclosed in the specification is not limited thereto. For example, as illustrated in FIG. 8, the binder and the powder may be alternately supplied several times into the forming chamber 34. In this case, multiple binder layers W1 and multiple powder layers W2 are alternately stacked in the forming chamber 34. Compressing such stacked binder layers W1 and powder layers W2 by the pusher member 44 facilitates the impregnation of the binder into each of the multiple powder layers W2, allowing the binder to permeate throughout the powder. Further, in case the binder and the powder are alternately supplied several times, for example, the binder and the powder may be compressed with a relatively small force by the pusher member 44 to form a provisional compact in which the binder has permeated in the powder layers W2. To form a powder compact W in this way, the binder and the powder are supplied again after the provisional compact has been formed, and these binder and powder are compressed to form another provisional compact. After this, the supply of powder, the supply of binder, and the provisional compression are repeated a predetermined number of times, and finally, the provisional compacts and the latest-supplied binder and powder are compressed with a relatively large force by the pusher member 44 to form a final powder compact W. This allows the binder to preferably permeate throughout the powder.

While specific examples of the present disclosure have been described above in detail, these examples are merely illustrative and place no limitation on the scope of the patent claims. The technology described in the patent claims also encompasses various changes and modifications to the specific examples described above. The technical elements explained in the present description or drawings provide technical utility either independently or through various combinations. The present disclosure is not limited to the combinations described at the time the claims are filed. Further, the purpose of the examples illustrated by the present description or drawings is to satisfy multiple objectives simultaneously, and satisfying any one of those objectives gives technical utility to the present disclosure.

1. A manufacturing method for a powder compact, comprising:
a material supplying step of separately supplying a binder and powder into a forming chamber, wherein the material supplying step comprises a binder supplying step of supplying the binder into the forming chamber and a powder supplying step of supplying the powder into the forming chamber; and
a pressure applying step of applying a pressure to the binder and the powder supplied into the forming chamber to impregnate the binder throughout the powder,
wherein in the material supplying step, the binder supplying step is performed first, and then the powder supplying step is performed.

2. The manufacturing method for the powder compact according to claim 1, wherein in the material supplying step, the binder supplying step and the powder supplying step are performed once or several times alternately to stack a binder layer and a powder layer alternately inside the forming chamber.

3. The manufacturing method for the powder compact according to claim 2, wherein in the pressure applying step, a first pressure is applied to the binder layer and the powder layer stacked inside the forming chamber to form the powder compact having a same shape as an internal shape of the forming chamber and in which the binder is impregnated throughout.

4. The manufacturing method for the powder compact according to claim 1, wherein
the material supplying step and the pressure applying step are performed n times alternately (n is an integer of 2 or more),
in first to (n−1)-th pressure applying steps, a second pressure is applied to the binder and the powder supplied into the forming chamber to form a provisional powder compact impregnated with the binder in the forming chamber,
a first material supplying step is performed when the provisional powder compact is not placed in the forming chamber,
second to n-th material supplying steps are performed when the provisional powder compact is placed in the forming chamber, and
in an n-th pressure applying step, a third pressure is applied to n−1 provisional powder compacts in the forming chamber and the binder and the powder supplied in the n-th material supplying step to form the powder compact impregnated with the binder, wherein the third pressure is greater than the second pressure.

5. The manufacturing method for the powder compact according to claim 3, further comprising a heating step of heating the powder compact formed by the pressure applying step.

6. A manufacturing apparatus for a powder compact, comprising:
a forming chamber;
a binder supplying device for supplying a binder to the forming chamber;
a powder supplying device for supplying powder to the forming chamber; and
a pusher,
wherein the forming chamber comprises an inlet through which the binder from the binder supplying device and the powder from the powder supplying device are supplied, and an accommodation space in which the binder and the powder supplied through the inlet are accommodated,
the pusher applies a pressure to the binder and the powder accommodated in the accommodation space, and
the powder supplying device is configured to supply the powder in the accommodation space when the binder is supplied to the accommodation space from the binder supplying device.

7. A manufacturing apparatus for a powder compact, comprising:
a forming chamber comprising an accommodation space capable of accommodating a binder and a powder; an inlet located at one end of the accommodation space, wherein the binder and the powder are supplied through the inlet; and an outlet located at other end of the accommodation space, wherein a powder compact formed by compressing the binder and the powder is ejected through the outlet;
a pusher movable into and out of the forming chamber through the inlet, wherein the pusher compresses the binder and the powder accommodated in the accommodation space; and
an opening/closing device for opening and closing the outlet,
wherein the opening/closing device comprises:
a door body capable of opening and closing the outlet; and
a first moving mechanism for moving the door body between a closed position where the door body closes the outlet and an open position where the door body opens the outlet, and
wherein the opening/closing device is configured to generate a shear force between the door body and the powder compact when the door body moves from the closed position to the open position after the powder compact has been formed,
the pusher is rotatable about an axis of the accommodation space within a predetermined angle range, and
the pusher is configured to move out of the forming chamber after rotating about the axis when the pusher moves out of the forming chamber after the powder compact has been formed.

8. The manufacturing apparatus for the powder compact according to claim 7, wherein
the door body is movable in a direction perpendicular to the axis of the accommodation space, and
the door body moves between the closed position and the open position by moving in the direction perpendicular to the axis.

9. The manufacturing apparatus for the powder compact according to claim 8, wherein
the door body is a plate-shaped member comprising a contact surface that contacts an outlet-side end surface of the forming chamber and a non-contact surface opposite to the contact surface,
the opening/closing device further comprises:
a pressing member contacting the non-contact surface of the door body; and
a second moving mechanism for moving the pressing member between a contact position where the pressing member contacts the non-contact surface of the door body at the closed position and a non-contact position where the pressing member does not contact the non-contact surface of the door body at the closed position, and
the pressing member is configured to press the door body toward the outlet-side end surface of the forming chamber when the door body moves from the open position to the closed position and the pressing member moves from the non-contact position to the contact position.

10. The manufacturing apparatus for the powder compact according to claim 9, wherein the opening/closing device further comprises a seal member disposed between the door body and the outlet-side end surface of the forming chamber to provide sealing between the contact surface of the door body and the outlet-side end surface of the forming chamber.

11. (canceled)

12. The manufacturing apparatus for the powder compact according to claim 7, wherein a clearance is formed between an inner surface of the accommodation space of the forming chamber and the pusher.

13. A forming apparatus for a powder compact, comprising:
a binder supplying device comprising a first supply port, wherein the binder supplying device supplies a binder from the first supply port;
a powder supplying device comprising a second supply port located at a position different from a position of the first supply port, wherein the powder supplying device supplies powder from the second supply port;
a forming chamber comprising an inlet, wherein the forming chamber accommodates the binder and the powder supplied through the inlet;
a moving device configured to move the forming chamber between a first position where the inlet corresponds to the first supply port and a second position where the inlet corresponds to the second supply port; and
a pusher compressing the binder and the powder accommodated in the forming chamber into a powder compact.

14. The forming apparatus for the powder compact according to claim 13, wherein
the moving device is further configured to move the forming chamber to a third position where the inlet corresponds to the pusher, and
the pusher is movable into and out of the forming chamber through the inlet when the forming chamber is moved to the third position by the moving device.

15. The forming apparatus for the powder compact according to claim 13, wherein
the forming chamber further comprises an outlet through which the powder compact is ejected from the forming chamber,
the moving device is further configured to move the forming chamber to a fourth position where the outlet is at a preset position, and
the powder compact in the forming chamber is able to be ejected through the outlet when the forming chamber is moved to the fourth position by the moving device.

16. The forming apparatus for the powder compact according to claim 15, wherein
the forming chamber further comprises an accommodation space capable of accommodating the binder and the powder,
the inlet is located at an upper end of the accommodation space, and
the outlet is located at a lower end of the accommodation space.
